(19) United States
(12) Patent Application Publication
(10) Pub. No.: US 2010/0328083 A1
(43) Pub. Date: Dec. 30, 2010

(54) SYSTEM FOR MONITORING ULTRAVIOLET RADIATION LEVELS IN A CURING CHAMBER AND METHOD OF MONITORING

(75) Inventor: Reilly Dillon, Golden Valley, MN (US)

Correspondence Address: SHERRILL LAW OFFICES, 4756 BANNING AVE, SUITE 212, WHITE BEAR LAKE, MN, 55110-3205, US

(73) Assignee: OAKRIVER TECHNOLOGIES INC., Oakdale, MN (US)

(21) Appl. No.: 12/676,937

(22) PCT Filed: Sep. 13, 2007
(86) PCT No.: PCT/US07/78382

§ 371 Date: Mar. 8, 2010

(51) Int. Cl. G08B 17/12; G01J 1/42

(52) U.S. Cl. 340/600; 250/372; 250/395

(57) ABSTRACT

A system and method for monitoring ultraviolet radiation levels within the cure chamber of an ultraviolet curing station. An ultraviolet sensor is located within a cure chamber for sensing the strength of ultraviolet radiation reaching the sensor. The sensor is repositionable within the cure chamber for taking readings at a plurality of locations. Sensor readings at a plurality of predetermined positions within the cure chamber are communicated to a controller and stored in electronic memory, along with an identification of the sensor position when the reading was obtained. A report is generated setting forth correlated sensor readings and reading locations, and providing any appropriate warnings of existing or impending equipment failure impacting the level of ultraviolet radiation in the cure chamber (e.g., a bulb failure).

### BACKGROUND OF THE INVENTION

Elongate flexible workpieces, such as guidewires and catheters, are often coated to provide a desired property or characteristic, such as enhanced lubricity, improved biological compatibility, anti-coagulation or rust resistance. The coating is commonly applied by dipping the workpiece into a coating solution, removing the workpiece from the coating solution, and curing the coating using heat or ultraviolet (UV) radiation.

Typical UV curing stations include a bank or array of UV bulbs along one wall of the curing station for emitting UV radiation into a cure chamber.

As UV bulbs approach the end of their useful life they tend to emit an increased or decreased intensity of UV radiation into the cure chamber, resulting in excessive or insufficient UV radiation at certain location within the cure chamber to achieve the desired cure. Early detection of failing bulbs is critical as excessively or insufficiently cured workpieces are prone to failure, and unless caught early can result in the need to dispose of a large number of suspect workpieces and even a recall.

The operational status of UV bulbs are currently checked on an ad hoc basis using a hand-held UV sensor. While significantly better than simply waiting for a bulb to fail completely, this procedure is inefficient and unreliable.

Accordingly, a continuing need exists for a system and method of consistently and reliably monitoring ultraviolet radiation levels throughout an ultraviolet curing chamber.

### SUMMARY OF THE INVENTION

A first aspect of the invention is a system for monitoring ultraviolet radiation levels within the cure chamber of an ultraviolet curing station. The system includes an ultraviolet sensor, a sensor repositioning means, a controller, electronic memory and an interface device. The ultraviolet sensor is located within the cure chamber for sensing the strength of any ultraviolet radiation reaching the sensor. The sensor repositioning means is capable of repositioning the sensor within the cure chamber. The controller is in electrical communication with the ultraviolet sensor and the sensor repositioning means for obtaining sensor readings at a plurality of predetermined positions within the cure chamber. The electronic memory records data comprising at least the sensor readings correlated with the sensor position when the reading was obtained. The interface device performs at least one of (i) reporting the recorded data in a human perceptible format, (ii) generating a perceptible warning signal when a sensor reading falls above a threshold value indicative of excessive ultraviolet radiation for achieving the desired cure, (iii) generating a perceptible warning signal when a sensor reading falls below a threshold value indicative of insufficient ultraviolet radiation for achieving the desired cure, and (iv) reporting a change in consecutive sensor readings at a single sensor position exceeding a threshold value indicative of an impending cure failure.

A second aspect of the invention is a method of monitoring ultraviolet curing within a cure chamber. The method includes the steps of (i) positioning an ultraviolet sensor at a defined location within an ultraviolet cure chamber, (ii) sensing the strength of any ultraviolet radiation reaching the positioned sensor, (iii) recording data comprising at least the sensor reading correlated with the sensor position when the reading was obtained, (iv) repositioning the ultraviolet sensor to a different defined location within the ultraviolet cure chamber, (v) repeating steps (ii) through (iv) at a plurality of defined locations to produce a data set comprising at least a plurality of sensor reading correlated with the sensor position when the reading was obtained, and generating a human perceptible report, comprising at least one of (i) a report of the data set, (ii) a report that a sensor reading fell above a threshold value indicative of excessive ultraviolet radiation for achieving the desired cure, and/or (iii) a report that a sensor reading fell below a threshold value indicative of insufficient ultraviolet radiation for achieving the desired cure.

The system and method is particularly suited for monitoring ultraviolet curing within a cure chamber when the source of UV radiation is a plurality of ultraviolet bulbs. For such applications, the defined locations at which the sensor senses the strength of ultraviolet radiation are selected so that a single ultraviolet bulb dominates the reading taken at each defined location. The report generated by the monitoring system includes an identification of the bulb emitting the ultraviolet radiation dominating the reading taken by the sensor, thereby allowing replacement of a bulb as soon as a sensor reading correlated to that bulb indicates excessive or insufficient ultraviolet radiation for achieving the desired cure.

### BRIEF DESCRIPTION OF THE DRAWINGS

FIG. 1 is a perspective view of one embodiment of the invention with the cure chamber door closed.

FIG. 2 is a front view of the invention shown in FIG. 1 with the cure chamber door fully open to facilitate viewing of internal components.

FIG. 3 is an electrical schematic of the invention shown in FIGS. 1 and 2.

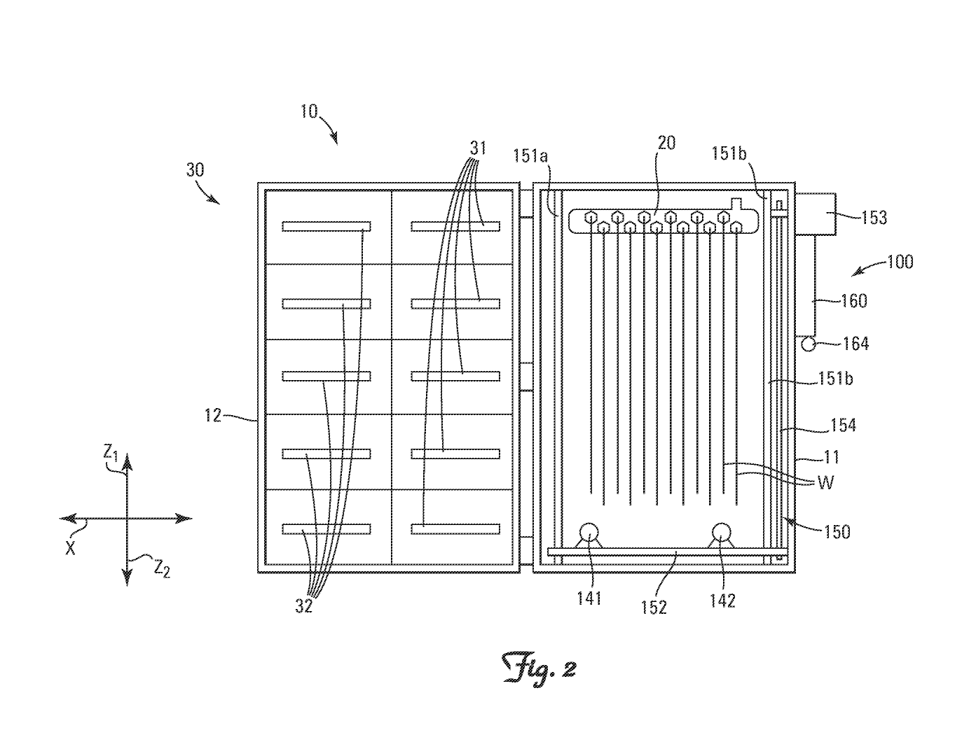

### DETAILED DESCRIPTION OF THE INVENTION

### Nomenclature

10 Ultraviolet Curing Station
11 Base Section of Station
12 Hinged Door on Station
19 Cure Chamber
20 Workpiece Support Assembly
30 Bank of Ultraviolet Bulbs
31 First Row of UV Bulbs
32 Second Row of UV Bulbs
100 Monitoring System
140 Ultraviolet Sensors
141 First UV Sensor
142 Second UV Sensor
150 Repositioning System
151 Styles
151a First Style
151b Second Style
152 Rail
153 Motor
154 Belt
160 Controller
161 Memory
162 Display Panel
163 Interface Port
164 Warning Light
W Workpiece
x Horizontal Direction
y Transverse Direction
z Vertical Direction
z₁ Upward Direction
z₂ Downward Direction

### Construction

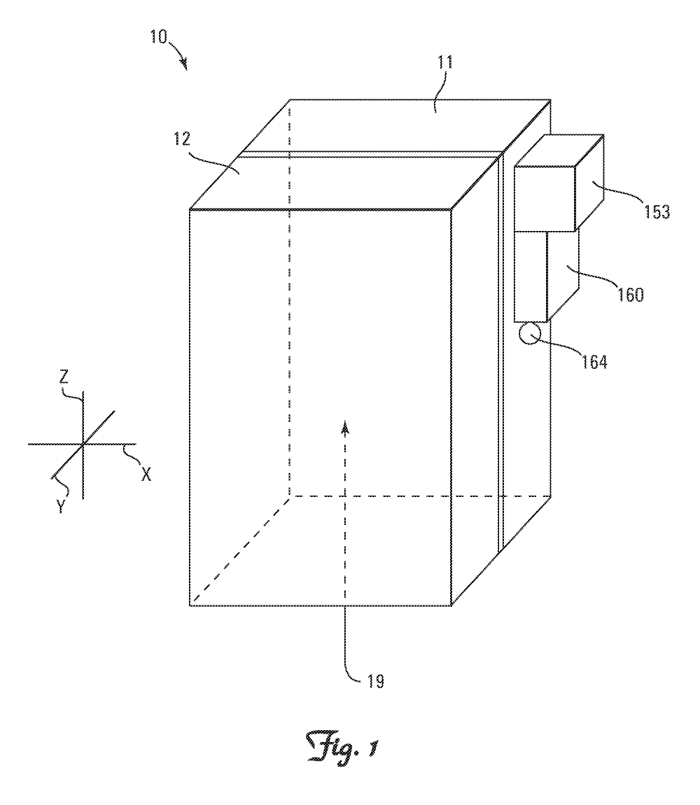

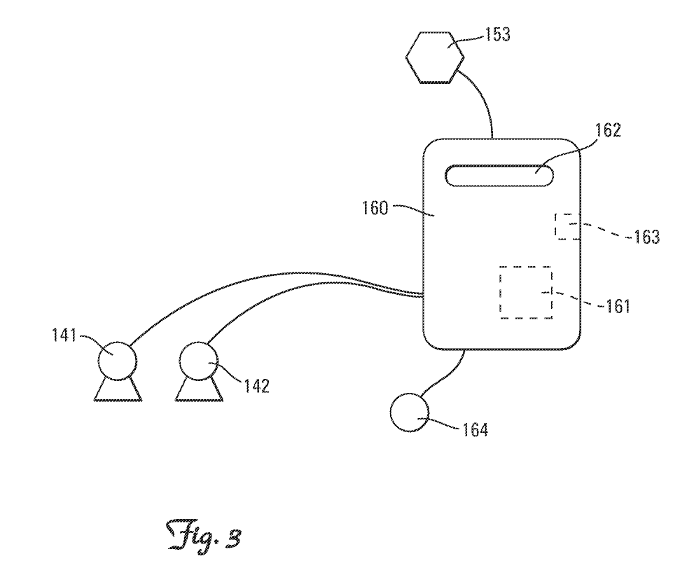

Referring to FIGS. 1 and 2, a “typical” ultraviolet curing station 10 is shown. The station 10 includes a base section 11 and a hinged door 12 defining a cure chamber 19. A workpiece support assembly 20 for releasably supporting coated workpieces W within the cure chamber 19 is provided on inside of the back wall (unnumbered) of the base section 11. A wide variety of different workpieces W can be cured using the station 10. FIG. 2 generically depicts elongate workpieces W such as guidewires and catheters, but the invention is not restricted to the curing of coatings on such workpieces W.

A source of ultraviolet radiation, typically a bank of ultraviolet bulbs 30, is provided on the inside of the door 12 for bathing the cure chamber 19 in ultraviolet radiation. The number and arrangement of the UV bulbs 30 can vary from station to station depending upon various design factors such as the size, shape and configuration of the cure chamber 19, the size, shape and configuration of the coated workpiece W, and the nature of the coating to be cured. For illustration purposes only, FIG. 2 depicts two columns of bulbs 31 and 32, each containing five bulbs.

Referring to FIG. 2, the monitoring system 100 includes at least one ultraviolet sensor 140 within the cure chamber 19, a sensor repositioning system 150, a controller 160, electronic memory 161 and a means for interfacing with an operator (not shown) and/or peripheral electronics (not shown).

The monitoring system 100 shown in FIG. 2 includes first 141 and second 142 ultraviolet sensors (collectively 140) transversely y spaced from the bank of ultraviolet bulbs 30, with each sensor 141 and 142 vertically aligned with one of the columns of bulbs 31 and 32 respectively. The desired sensing could also be performed with a single sensor 140 provided the sensor repositioning system 150 can repositioning the sensor 140 both vertically z and horizontally x. Ultraviolet sensors 140 suitable for use in this invention are widely available from a number of suppliers.

The sensor repositioning system 150 needs to be able to reposition the sensor(s) 140 within the cure chamber 19 so that readings can be taken at various locations throughout the chamber 19. While three-dimensional repositioning of the sensor(s) 140 within the cure chamber 19 can be achieved, I have discovered that sufficient information can be obtained by sensing ultraviolet levels within a single vertical plane z.

Referring to FIG. 2, the depicted sensor repositioning system 150 is attached to the base 11 for moving the sensors upward z₁ and downward z₂ within a vertical z plane. The sensors 140 are mounted onto a horizontal rail 152. The horizontal rail 152 slidably engages horizontally x spaced vertical z styles 151a and 151b (collectively 151). The rail 152 can be vertically z repositioned along the styles 151 by a drive system such as a motor 153 and a belt 154. Other repositioning systems and drive systems known to those of routine skill in the art can also be employed, including pneumatic, hydraulic and/or electrically powered systems.

Repositioning of the sensor(s) 140 is controlled by a suitable controller 160. The controller 160 is also preferably equipped with a display panel 162 for communicating directly with an operator, an interface port 163 form communicating with a peripheral device (not shown) such as a CPU, printer, keyboard etc., and/or a warning signal such as a warning light 164, buzzer (not shown), etc.

Sensor readings are taken at a plurality of predetermined locations within the cure chamber 19. Sensor readings, correlated with the sensor 140 position when the reading was obtained, is communicated to and stored in electronic memory 161. This data can then be reported to an operator (not shown) in any number of ways. The data may simply be printed or displayed in a human perceptible format. Alternatively, a perceptible warning signal may be generated when (i) a sensor reading falls above a threshold value indicative of excessive ultraviolet radiation for achieving the desired cure, (ii) a sensor reading falls below a threshold value indicative of insufficient ultraviolet radiation for achieving the desired cure, and/or (iii) reporting a change in consecutive sensor readings at a single sensor position exceeding a threshold value indicative of an impending cure failure. The nature of the perceptible warning signal can be selected from a wide range of signals such as activating a warning light 164, activating a warning buzzer (not shown), displaying a warning message on the display panel 162, displaying a warning message on an attached monitor (not shown), printing a warning message on a printout (not shown) generated upon the completion of each monitoring cycle, etc.

The monitoring system 100 can greatly simply the identification and replacement of a failing bulb in a bank of bulbs 30 by (i) programming the controller 160 to take sensor readings at locations where the ultraviolet radiation sensed by the sensor is dominated by the ultraviolet radiation emitted by a single bulb, (ii) correlating these sensor readings with an identification of the bulb emitting the ultraviolet radiation dominating the reading taken by the sensor 140, and (iii) reporting a bulb as “failing” when a sensor reading correlated to that bulb indicates excessive or insufficient ultraviolet radiation for achieving the desired cure.

### Use

The strength of ultraviolet radiation provided throughout a cure chamber 19 can be monitored for ensuring lot quality assurance, permitting preventative maintenance, and/or facilitating the identification of equipment in need of repair and/or replacement. Monitoring involves the steps of (i) sensing the strength of ultraviolet radiation reaching an ultraviolet sensor 140 positioned at a defined location within the cure chamber 19, (ii) recording data comprising at least the sensor reading correlated with the sensor position when the reading was obtained, (iii) repositioning the ultraviolet sensor 140 to a different defined location within the cure chamber 19, (iv) repeating steps (i) through (iii) at a plurality of defined locations to produce a data set comprising at least a plurality of sensor reading correlated with the sensor position when the reading was obtained, and (v) generating a human perceptible report, comprising at least one of (a) a report of the data set, (b) a report that a sensor reading fell above a threshold value indicative of excessive ultraviolet radiation for achieving the desired cure, and/or (c) a report that a sensor reading fell below a threshold value indicative of insufficient ultraviolet radiation for achieving the desired cure.

A monitoring cycle can be performed on any desired schedule, but is preferably performed prior to each cure cycle (i.e., placing a workpiece W coated with an ultraviolet curable material within the cure chamber 19, (ii) curing the coating, and (iii) removing the workpiece W with a cured coating from the curing chamber 19) to minimize the possibility that product was defectively cured in the cure chamber 19 between monitoring cycles.

By repeating monitoring cycles over time and taking sensor readings at the same defined locations, a performance profile can be obtained for each location. An unusual or unexpected change in a performance profile can then be used as an indicator of an impending equipment failure (e.g., bulb failure) and a preemptive repair or replacement can be completed.

The monitoring system 100 can facilitate replacement of failing bulbs, often prior to actual failure, by simply (i) taking sensor readings at locations where the ultraviolet radiation sensed by the sensor is dominated by the ultraviolet radiation emitted by a single bulb, (ii) correlating each sensor reading with an identification of the bulb emitting the ultraviolet radiation dominating the reading taken by the sensor 140, and (iii) reporting a bulb as “failing” when a sensor reading correlated to that bulb indicates (a) excessive or insufficient ultraviolet radiation for achieving the desired cure, or (b) a change in consecutive sensor readings exceeding a threshold value indicative of an impending cure failure. Upon receiving such a report, an operator need merely located and replace the bulb identified in the report as “failing”.

I claim:

1. A monitoring system for an ultraviolet curing station, comprising:
(a) a cure chamber,
(b) source of ultraviolet radiation configured and arranged to transmit ultraviolet radiation into the cure chamber,
(c) an ultraviolet sensor within the cure chamber capable of sensing the strength of any ultraviolet radiation reaching the sensor,
(d) a means for repositioning the sensor within the cure chamber,
(e) a controller in electrical communication with the ultraviolet sensor and the sensor repositioning means for obtaining sensor readings at a plurality of predetermined positions within the cure chamber,
(f) electronic memory for recording data comprising at least the sensor readings correlated with the sensor position when the reading was obtained, and
(g) an interface device for performing at least one of (i) reporting the recorded data in a human perceptible format, (ii) generating a perceptible warning signal when a sensor reading falls above a threshold value indicative of excessive ultraviolet radiation for achieving the desired cure, (iii) generating a perceptible warning signal when a sensor reading falls below a threshold value indicative of insufficient ultraviolet radiation for achieving the desired cure, and (iv) reporting a change in consecutive sensor readings at a single sensor position exceeding a threshold value indicative of an impending cure failure.

2. The monitoring system of claim 1 wherein the ultraviolet curing station is a station for curing a coating on a catheter or guidewire.

3. The monitoring system of claim 1 wherein (i) the source of ultraviolet radiation is a bank of ultraviolet bulbs positioned along one wall of the cure chamber, (ii) the sensor is positioned proximate a second wall opposite the one wall, and (iii) each predetermined position positions the sensor to take a reading dominated by the ultraviolet radiation emitted by one of the bulbs in the bank.

4. The monitoring system of claim 3 wherein the sensor readings are correlated with an identification of the bulb emitting the ultraviolet radiation dominating the reading taken by the sensor.

5. The monitoring system of claim 1 wherein the interface device reports the recorded data in a human perceptible format.

6. The monitoring system of claim 1 wherein the interface device generates a perceptible warning signal when a sensor reading falls above a threshold value indicative of excessive ultraviolet radiation for achieving the desired cure.

7. The monitoring system of claim 4 wherein the interface device identifies a bulb for replacement when a sensor reading correlated to that bulb falls above a threshold value indicative of excessive ultraviolet radiation for achieving the desired cure.

8. The monitoring system of claim 1 wherein the interface device generates a perceptible warning signal when a sensor reading falls below a threshold value indicative of insufficient ultraviolet radiation for achieving the desired cure.

9. The monitoring system of claim 4 wherein the interface device identifies a bulb for replacement when a sensor reading correlated to that bulb falls below a threshold value indicative of insufficient ultraviolet radiation for achieving the desired cure.

10. A method of monitoring ultraviolet curing within a cure chamber, comprising the steps of:
(a) positioning an ultraviolet sensor at a defined location within an ultraviolet cure chamber,
(b) sensing the strength of any ultraviolet radiation reaching the positioned sensor,
(c) recording data comprising at least the sensor reading correlated with the sensor position when the reading was obtained,
(d) repositioning the ultraviolet sensor to a different defined location within the ultraviolet cure chamber,
(e) repeating steps (b) through (d) at a plurality of defined locations to produce a data set comprising at least a plurality of sensor reading correlated with the sensor position when the reading was obtained, and
(f) generating a human perceptible report, comprising at least one of (i) a report of the data set, (ii) a report that a sensor reading fell above a threshold value indicative of excessive ultraviolet radiation for achieving the desired cure, and/or (iii) a report that a sensor reading fell below a threshold value indicative of insufficient ultraviolet radiation for achieving the desired cure.

11. The method of claim 10 further comprising the steps of performing a cure cycle upon completion of step (e), including the steps of (i) placing a device coated with an ultraviolet curable material within the cure chamber, (ii) curing the coating, and (iii) removing the device with a cured coating from the curing chamber.

12. The method of claim 10 further comprising the step of periodically repeating steps (a) through (e) at the same defined locations.

13. The method of claim 11 further comprising the step of periodically repeating steps (a) through (e) at the same defined locations.

14. The method of claim 12 wherein the human perceptible reports includes a report of any change in consecutive sensor readings at a single location exceeding a threshold value indicative of an impending cure failure.

15. The method of claim 13 wherein the human perceptible reports includes a report of any change in consecutive sensor readings at a single location exceeding a threshold value indicative of an impending cure failure.

16. The method of claim 11 further comprising the step of periodically repeating steps (a) through (e) at the same defined locations.

17. The method of claim 16 wherein the steps (a) through (e) are repeated with each cure cycle.

18. The method of claim 11 wherein (i) curing is effected by a plurality of ultraviolet bulbs emit ultraviolet radiation into the cure chamber, (ii) a single ultraviolet bulb dominates the reading taken at each defined location, (iii) the report includes an identification of the bulb emitting the ultraviolet radiation dominating the reading taken by the sensor, and (iv) the method further includes the step of replacing a bulb when a sensor reading correlated to that bulb indicates excessive or insufficient ultraviolet radiation for achieving the desired cure.

19. The method of claim 15 wherein (i) curing is effected by a plurality of ultraviolet bulbs emit ultraviolet radiation into the cure chamber, (ii) a single ultraviolet bulb dominates the reading taken at each defined location, (iii) the report includes an identification of the bulb emitting the ultraviolet radiation dominating the reading taken by the sensor, and (iv) the method further includes the step of replacing a bulb when a change in consecutive sensor readings correlated to that bulb exceeds a threshold value indicative of an impending cure failure.
